(19) United States
(12) Patent Application Publication
(10) Pub. No.: US 2026/0355716 A1
(43) Pub. Date: Nov. 12, 2026

(54) METHOD FOR MANUFACTURING DRY-TYPE CARBON DIOXIDE ADSORBING MOLDING

(71) Applicant: KOREA INSTITUTE OF MACHINERY & MATERIALS, Daejeon (KR)

(72) Inventors: Daehoon PARK, Daejeon (KR); Bangwoo HAN, Daejeon (KR); Younghun KIM, Daejeon (KR); Inyong PARK, Daejeon (KR); Gunhee LEE, Daejeon (KR); Sang Bok KIM, Daejeon (KR); Keejung HONG, Daejeon (KR)

(21) Appl. No.: 19/491,063

(22) PCT Filed: Nov. 21, 2024
(86) PCT No.: PCT/KR2024/018558

§ 371 Date: Dec. 8, 2025

(30) Foreign Application Priority Data
Nov. 29, 2023 (KR) 10-2023-0168919

(51) Int. Cl. B01J 20/26; B01D 53/02; B01J 20/28; B01J 20/30; B01J 20/32

(52) U.S. Cl. CPC B01J 20/262; B01D 53/02; B01J 20/28095; B01J 20/3007; B01J 20/3042; B01J 20/3272; B01D 2253/202; B01D 2253/25; B01D 2257/504

(57) ABSTRACT

A method for manufacturing a dry-type carbon dioxide adsorbing molding manufactured in a large quantity and having a small pressure loss and a high adsorption rate that is applicable to a device for reducing a greenhouse gas of a small and medium-sized ship to which a one-pass format is applied includes: sintering a support provided by extrusion molding a mixture of a support raw material and a binder at a predetermined temperature; synthesizing an adsorbent by mixing a solvent, an amine compound, and a structure-directing agent in a reaction container; and physically impregnating the adsorbent into a pore of the support and then drying the adsorbent.

### CROSS-REFERENCE TO RELATED APPLICATION(S)

This application claims priority to and the benefit of Korean Patent Application No. 10-2023-0168919 filed with the Korean Intellectual Property Office on Nov. 29, 2023, the entire contents of which are incorporated herein by reference.

### TECHNICAL FIELD

The present disclosure relates to a method for manufacturing a dry-type carbon dioxide adsorbing molding, and more particularly, to a method for manufacturing a dry-type carbon dioxide adsorbing molding for a small and medium-sized ship that is manufactured in a large quantity and has a small pressure loss and a high adsorption rate.

### BACKGROUND ART

As ship exhaust gas regulation has recently become stricter in an era of carbon neutrality, a need for technology capable of reducing a greenhouse gas (particularly, CO₂) in an exhaust gas of a ship has emerged.

An exhaust gas reduction device is generally focused on reducing SOₓ, NOₓ, or particulate matter, and a reduction device that reduces the greenhouse gas is only installed as a wet-type device for a large ship.

However, because the number of small and medium-sized ships is much greater in a coastal area, a system for reducing a greenhouse gas in an exhaust gas of the small and medium-sized ship is needed to effectively prevent air pollution caused by the exhaust gas of the small and medium-sized ship.

However, a system for reducing the greenhouse gas in the exhaust gas is intensively developed for the large ship so that the system itself is expensive, and a device for reducing the greenhouse gas for the large ship may not be installed at the small and medium-sized ship due to weight and volume problems.

Accordingly, there is no technology for reducing the greenhouse gas applicable to an actual small and medium-sized ship. Therefore, it is necessary to develop a small and lightweight adsorbent applicable to an adsorption system for adsorbing the greenhouse gas suitable for the small and medium-sized ship.

In a dry-type carbon dioxide adsorbent conventionally used for another purpose, a method in which a powder-type adsorbent flows through a fluidized layer to adsorb carbon dioxide without a separate molding process is mainly used

A device for reducing the exhaust gas for the small and medium-sized ship should reduce carbon dioxide in a one-pass format so that it is difficult to expect a high adsorption rate because a pressure loss is too large and an energy loss for a flow is large when a powder-type carbon dioxide adsorbent is used.

One-pot synthesis is introduced as a method for manufacturing a conventional dry-type carbon dioxide adsorbent. The one-pot synthesis refers to a method in which a reactant is continuously added to one reaction container without separately purifying an intermediate product when a final compound is synthesized through a plurality of reaction processes.

According to the conventional one-pot synthesis, a support raw material and an adsorbent raw material are put in one reaction container at the same time to react the support raw material with the adsorbent raw material, and then a final adsorbing molding is completed through drying, grinding, and molding processes. However, there is a problem in which each process takes a lot of time so that large-quantity manufacturing is realistically difficult.

### DISCLOSURE

### Technical Problem

Embodiments of the present disclosure are intended to provide a method for manufacturing a dry-type carbon dioxide adsorbing molding manufactured in a large quantity and having a small pressure loss and a high adsorption rate that is applicable to a device for reducing a greenhouse gas of a small and medium-sized ship to which a one-pass format is applied.

Embodiments of the present disclosure are intended to provide a dry-type carbon dioxide adsorbing molding manufactured by the above method.

Problems of the present disclosure are not limited to the problems mentioned above, and other problems not mentioned will be clearly understood by a person having ordinary skill in the art to which the present disclosure belongs from the following description.

### Technical Solution

A method for manufacturing a dry-type carbon dioxide adsorbing molding according to an embodiment of the present disclosure includes: sintering a support provided by extrusion molding a mixture of a support raw material and a binder at a predetermined temperature; synthesizing an adsorbent by mixing a solvent, an amine compound, and a structure-directing agent in a reaction container; and physically impregnating the adsorbent into a pore of the support and then drying the adsorbent.

The binder may be included in an amount of 50 to 70 parts by weight based on 100 parts by weight of the support raw material.

The support raw material may include at least one selected from the group consisting of bentonite, attapulgite, kaolinite, montmorillonite, ball clay, fuller's earth, hectorite, palygorskite, saponite, sepiolite, halloysite, silica, calcium sulfate, zeolite, synthetic zeolite, alumina, fumed silica, activated charcoal, and metal organic framework.

The binder may include methyl cellulose.

The support may be sintered at 500 to 600 degrees.

The support may have a polyhedral shape, a polygonal columnar shape, or a cylindrical shape.

The synthesizing of the adsorbent may be reacted without silicate.

The adsorbent may include 25 to 35 wt % of an amine compound, 2 to 8 wt % of a structure-directing agent, and the remaining wt % of a solvent.

The solvent may include at least one selected from the group consisting of water, methanol, ethanol, methyl chloride, carbon tetrachloride, and tetrahydrofuran.

The amine compound may include at least one selected from the group consisting of ethylenediamine, triethylenetetramine, tetraethylenepentamine, pentaethylenehexamine, hexaethyleneheptamine, polyethyleneimine, and polypropyleneimine.

The amine compound may be polyethyleneimine modified by partial substitution with epoxybutane.

The structure-directing agent may include at least one selected from the group consisting of tetramethylammonium phosphate (TMAH₂PO₄), tetraethylammonium phosphate (TEAH₂PO₄), tetrapropylammonium phosphate (TPAH₂PO₄), and tetrabutylammonium phosphate (TBAH₂PO₄).

A dry-type carbon dioxide adsorbing molding according to an embodiment of the present disclosure is manufactured according to the method.

The synthesizing of the adsorbent may be a synthesis reaction without sodium silicate.

The adsorbent may include 29.1 wt % of the amine compound, 4.7 wt % of the structure-directing agent, and 66.2 wt % of the solvent.

The adsorbing molding may be used in a device for reducing a greenhouse gas of a small and medium-sized ship that reduces carbon dioxide in a one-pass format.

Specific details of other embodiments are included in the detailed description and the drawings.

### Advantageous Effects

According to a method for manufacturing a dry-type carbon dioxide adsorbing molding according to the present disclosure and a dry-type carbon dioxide adsorbing molding manufactured by the method, molding of a support and synthesis of an adsorbent may be independently performed without following one-pot synthesis in a series of time-series processes and then the adsorbing molding may be completed by impregnating the adsorbent into a pore of the support so that large-quantity manufacturing is possible by dramatically shortening a manufacturing time.

A fumed silica that is generally used as a support raw material may be too light to have a scattering characteristic so that it is very difficult to directly mold a polyhedral support, a polygonal columnar support, or a cylindrical support from the support raw material. The present disclosure may mold (or form) a high-strength support by extruding a mixture of a support raw material and a binder and then sintering the molded mixture at a high temperature (e.g., 500 to 600 degrees or 550 degrees). Furthermore, excellent performance of the support of the present disclosure is confirmed in terms of a total pore volume and an average adsorption efficiency for 5 minutes.

Because the present disclosure independently performs the molding of the support and the synthesis of the adsorbent, there is no need to add silicate (e.g., sodium silicate) that is an additive that helps bonding of the support raw material during the synthesis of the adsorbent. Therefore, as a result of comparing an experimental group according to the present disclosure with a control group (i.e., sodium silicate added to the adsorbent), it is confirmed that an average carbon dioxide adsorption efficiency for 5 minutes is increased by 3% or more and an average duration time of a 15% carbon dioxide adsorption efficiency is increased by 30% or more.

### DESCRIPTION OF THE DRAWINGS

FIG. 1 is a flow chart showing a method for manufacturing a dry-type carbon dioxide adsorbing molding according to an embodiment of the present disclosure.

FIG. 2A is a graph showing a result of a nitrogen isothermal adsorption experiment according to a BET analysis.

FIG. 2B is a graph showing a total pore volume and an average adsorption efficiency for 5 minutes measured according to the BET analysis.

FIG. 3 is a configuration diagram showing a one-pass reduction device that imitates an exhaust gas reduction device for a ship provided to measure a carbon dioxide adsorption efficiency.

FIG. 4 is a graph measuring a concentration of carbon dioxide using the one-pass reduction device.

FIG. 5 is a graph measuring a carbon dioxide adsorption efficiency using the one-pass reduction device.

FIG. 6 is a graph measuring a carbon dioxide adsorption efficiency using the one-pass reduction device.

FIG. 7 is a graph measuring a carbon dioxide adsorption efficiency according to a carbon dioxide atmosphere using the one-pass reduction device.

### MODE FOR INVENTION

An advantage and a feature of the present disclosure and a method for achieving them may become apparent with reference to embodiments described below in detail together with the accompanying drawings. However, the present disclosure is not limited to the embodiments disclosed below, but may be implemented in various forms. That is, the following embodiments may be provided so that the present disclosure is complete, and the embodiments may be provided to fully inform those of ordinary skill in a technical field to which the present disclosure belongs of the scope of the invention. The present disclosure may be defined by the scope of the claims. Throughout the specification, the same reference numerals refer to the same components.

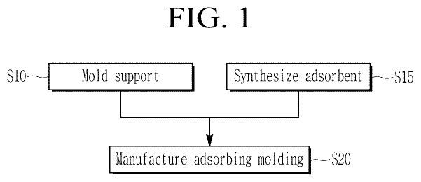

Hereinafter, a method for manufacturing a dry-type carbon dioxide adsorbing molding (or a dry-type carbon dioxide adsorbing molded body) according to an embodiment of the present disclosure will be described in detail with reference to the attached drawings. FIG. 1 is a flow chart showing the method for manufacturing the dry-type carbon dioxide adsorbing molding according to the embodiment of the present disclosure.

In the dry-type carbon dioxide adsorbing molding according to the embodiment of the present disclosure, molding S10 of a support and synthesis S15 of an adsorbent may be independently performed in parallel for large-quantity manufacturing. That is, while the support is molded (or formed), the adsorbent may be synthesized using a separate reaction container. Hereinafter, each process will be described in detail.

The support may be provided by extrusion molding a mixture of a support raw material and a binder, and the support may be sintered at a predetermined temperature (S10).

The support raw material may include at least one selected from the group consisting of bentonite, attapulgite, kaolinite, montmorillonite, ball clay, fuller's earth, hectorite, palygorskite, saponite, sepiolite, halloysite, silica, calcium sulfate, zeolite, synthetic zeolite, alumina, fumed silica, activated charcoal, and metal organic framework. For example, the support raw material may include the fumed silica. The fumed silica may be synthetic silica manufactured by a dry method, may be a high-purity material of 99.9% or more, and may be manufactured by gas-phase thermal decomposition of a chlorosilane compound.

The binder may be an organic binder that binds the support raw material, and may include methyl cellulose. The binder may be included in an amount of 50 to 70 parts by weight based on 100 parts by weight of the support raw material. The binder may be included in an amount of 60 parts by weight based on 100 parts by weight of the support raw material.

The support molded by the extrusion may be sintered in an air atmosphere at 500 to 600 degrees or 550 degrees for 2 to 5 hours. The sintering temperature may affect a pore volume of the support, whether the binder remains, or the like.

If the sintering temperature is lower than 500 degrees, the binder may remain within a porous support so that an adsorption efficiency of carbon dioxide is reduced, and if the sintering temperature is higher than 600 degrees, the binder may be removed by high heat, but a pore volume within the support may be reduced so that the adsorption efficiency of carbon dioxide is reduced.

The support molded by the extrusion may have a polyhedral shape, a polygonal columnar shape, or a cylindrical shape. The support may be extruded in a pellet or honeycomb form.

Separately from molding of the support, the adsorbent may be synthesized by mixing a solvent, an amine compound, and a structure-directing agent in a reaction container (S15). In the present embodiment, the adsorbent may be synthesized for 1 to 2 hours at a room temperature.

The solvent may include one or more selected from the group consisting of water, methanol, ethanol, methyl chloride, carbon tetrachloride, and tetrahydrofuran. For example, the solvent may include water.

The amine compound may include at least one selected from the group consisting of ethylenediamine, triethylenetetramine, tetraethylenepentamine, pentaethylenehexamine, hexaethyleneheptamine, polyethyleneimine, and polypropyleneimine. For example, the amine compound may include polyethyleneimine. In some embodiments, the amine compound may be polyethyleneimine (EB-PEI) modified by partial substitution with epoxybutane.

The structure-directing agent may be a compound that forms a skeleton of the support, and may serve as a template for forming a specific structure. The structure-directing agent may include at least one selected from the group consisting of tetramethylammonium phosphate (TMAH₂PO₄), tetraethylammonium phosphate (TEAH₂PO₄), tetrapropylammonium phosphate (TPAH₂PO₄), and tetrabutylammonium phosphate (TBAH₂PO₄). For example, the structure-directing agent may include tetraethylammonium phosphate.

Because the molding S10 of the support and the synthesis S15 of the adsorbent are independently performed in the present embodiment, the step of synthesizing the adsorbent may not add an additive that helps binding of the support raw material.

In some embodiments, a synthesis reaction may be performed without silicate that is the additive during the synthesis of the adsorbent. For example, the synthesis reaction may be performed without sodium silicate that is the additive during the synthesis of the adsorbent.

The adsorbent may include 25 to 35 wt % of an amine compound, 2 to 8 wt % of a structure-directing agent, and the remaining wt % (e.g., 57 to 73 wt %) of a solvent. For example, the adsorbent may include 29.1 wt % of the amine compound, 4.7 wt % of the structure-directing agent, and 66.2 wt % of the solvent.

The adsorbent may be physically impregnated into a pore of the support and then may be dried using the support and the adsorbent independently provided (S20). In the present embodiment, the support may be put in the adsorbent of the reaction container and may be impregnated for a predetermined time, and then the support may be separated and may be dried at a room temperature in an air atmosphere for a predetermined time. Thus, a solvent may be removed to complete a final adsorbing molding. The adsorbing molding of the present embodiment may be used in a device for reducing a greenhouse gas of a small and medium-sized ship that reduces carbon dioxide in a one-pass format.

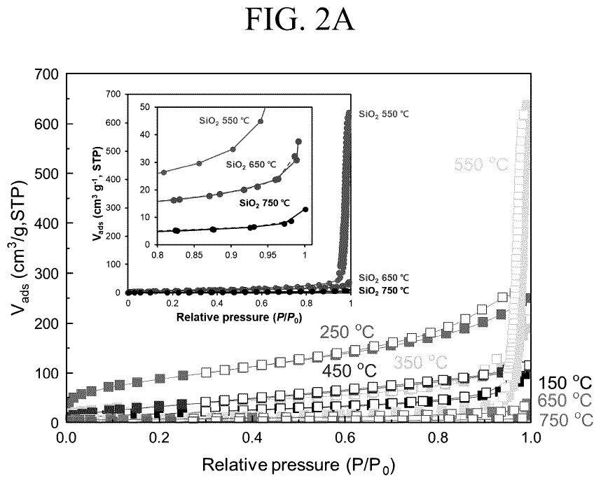

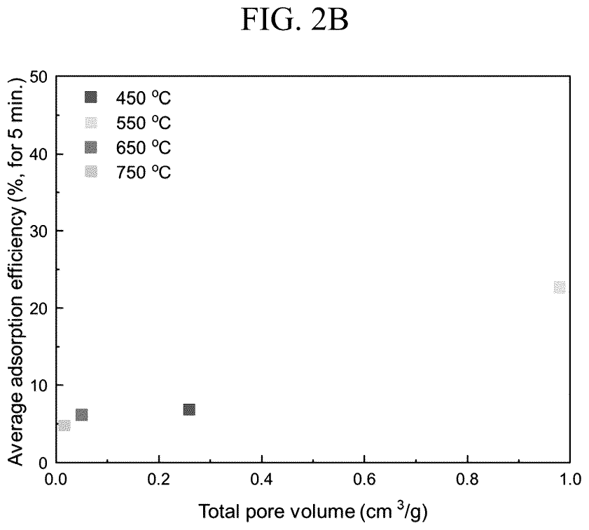

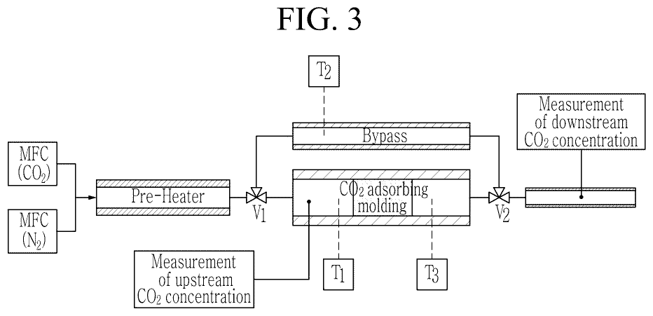

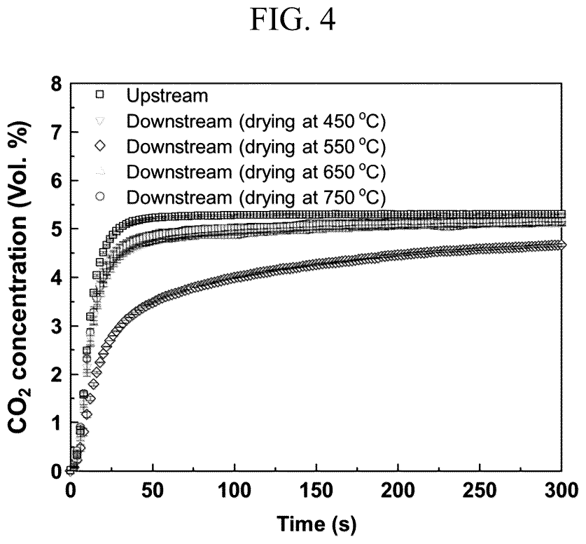

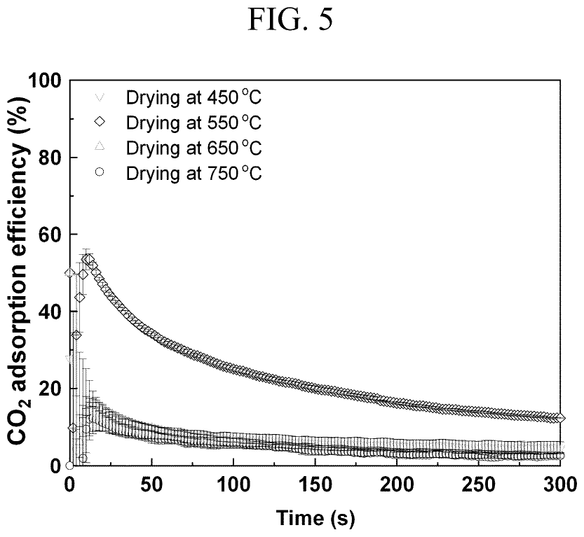

Hereinafter, a performance measurement result of the dry-type carbon dioxide adsorbing molding according to the sintering temperature will be described with reference to FIGS. 2A to 5. FIG. 2A is a graph showing a result of a nitrogen isothermal adsorption experiment according to a BET analysis. FIG. 2B is a graph showing a total pore volume and an average adsorption efficiency for 5 minutes measured according to the BET analysis. FIG. 3 is a configuration diagram showing a one-pass reduction device that imitates an exhaust gas reduction device for a ship provided to measure a carbon dioxide adsorption efficiency. FIG. 4 is a graph measuring a concentration of carbon dioxide using the one-pass reduction device. FIG. 5 is a graph measuring a carbon dioxide adsorption efficiency using the one-pass reduction device.

In the present experimental example, 100 parts by weight of fumed silica and 60 parts by weight of methyl cellulose are mixed, extruded, and then sintered at various sintering temperatures (e.g., 450, 550, 650, and 750 degrees) in an air atmosphere to manufacture the support. Additionally, 29.1 wt % of polyethyleneimine (EB-PEI) modified by partial substitution with epoxybutane, 4.7 wt % of tetraethylammonium phosphate (TEAH₂PO₄), 11.1 wt % of water, and 55.1 wt % of ethanol (C₂H₆O) are mixed in a reaction container to synthesize the adsorbent at a room temperature. Next, the adsorbent is impregnated into a pore of the support and then is dried at a room temperature in an air atmosphere to complete a final adsorbing molding.

TABLE 1

| | Sintering temperature (°C) | | | |
|---|---|---|---|---|
| | 450 | 550 | 650 | 750 |
| BET surface area (S_{BET} | 120.94 | 31.6 | 24.8 | 6.1 |
| (m²/g)) | | | | |
| Total pore volume (Vₜₒₜₐₗ | 0.26 | 0.98 | 0.052 | 0.017 |
| (cm³/g)) | | | | |
| Average adsorption | 6.85 | 22.64 | 6.19 | 4.77 |
| efficiency for 5 min (%) | | | | |
| CO₂ adsorbed for 5 min | — | 0.436 | — | 0.084 |
| (mmol/g) | | | | |

As shown in FIG. 2A, FIG. 2B, and Table 1, it is confirmed that a nitrogen gas absorption volume (V_{ads}) per unit mass of the adsorbing molding when the sintering temperature is 550 degrees is significantly larger than a nitrogen gas absorption volume (V_{ads}) per unit mass of the adsorbing molding at another sintering temperature. In addition, it is confirmed that the total pore volume measured when the sintering temperature is 550 degrees that is 0.98 cm³/g and the average adsorption efficiency for 5 minutes measured when the sintering temperature is 550 degrees that is 22.64% are significantly larger than the total pore volume measured and the average adsorption efficiency for 5 minutes at another sintering temperature.

The one-pass reduction device of FIG. 3 may operate as follows. Carbon dioxide and nitrogen supplied through two MFCs may be heated to a temperature range of an actual exhaust gas using a pre-heater and then may be supplied into a reactor. A concentration of the carbon dioxide may be measured before and after the adsorbing molding disposed inside the reactor. In addition, adsorption and desorption may be controlled using a bypass flow path connected in parallel to the reactor and two valves V1 and V2 disposed at both sides of the bypass flow path.

In FIG. 4 and FIG. 5, the adsorbing molding is put in the one-pass reduction device of FIG. 3, 5% of CO₂ and 95% of N₂ are flowed at 50 liter/min (LPM), and adsorption capacity is measured while 50 liter/min (LPM) is maintained at 60 degrees for 5 minutes. “Upstream” indicates a concentration of the carbon dioxide before the carbon dioxide passes through the adsorbing molding within the one-pass reduction device, and “Downstream” indicates a concentration of the carbon dioxide after the carbon dioxide passes through the adsorbing molding. “drying at 450 °C”, “drying at 550 °C”, “drying at 650 °C”, and “drying at 750 °C” represent adsorbing moldings sintered at 450 °C, 550 °C, 650 °C, and 750 °C, respectively. As shown in FIG. 4, FIG. 5, and Table 1, it is confirmed that the carbon dioxide adsorbed for 5 minutes measured when the sintering temperature is 550 degrees that is 0.436 mmol/g is significantly larger than the carbon dioxide adsorbed for 5 minutes at another sintering temperature.

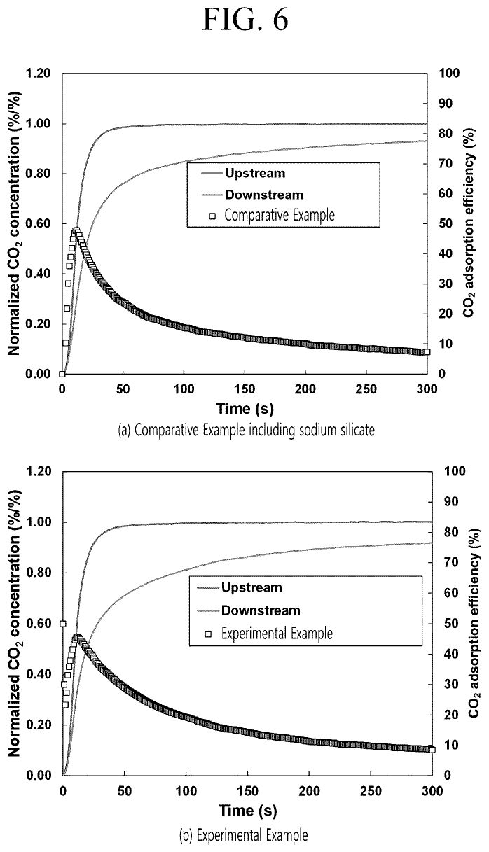

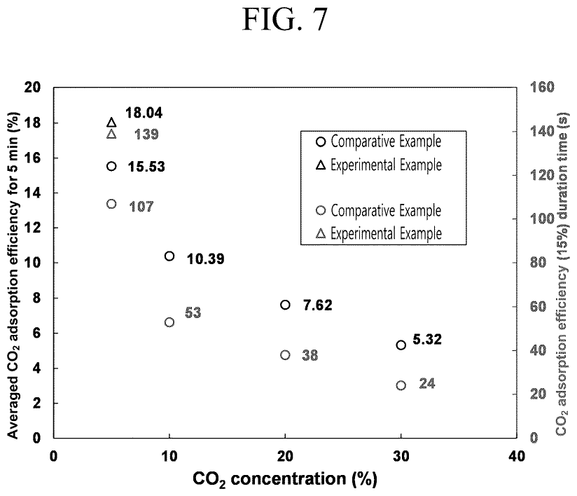

Hereinafter, an effect of removing silicate in the synthesis of the adsorbent will be described with reference to FIG. 6 and FIG. 7. FIG. 6 is a graph measuring a carbon dioxide adsorption efficiency using the one-pass reduction device. FIG. 7 is a graph measuring a carbon dioxide adsorption efficiency according to a carbon dioxide atmosphere using the one-pass reduction device. In the present embodiment, the carbon dioxide adsorption efficiency may have substantially the same meaning as a carbon dioxide removal efficiency of the one-pass reduction device.

In the present experimental example, 100 parts by weight of fumed silica and 60 parts by weight of methyl cellulose are mixed, extruded, and then sintered at 550 degrees in an air atmosphere to manufacture the support. Additionally, 29.1 wt % of polyethyleneimine (EB-PEI) modified by partial substitution with epoxybutane, 4.7 wt % of tetraethylammonium phosphate (TEAH₂PO₄), 11.1 wt % of water, and 55.1 wt % of ethanol (C₂H₆O) are mixed in a reaction container to synthesize the adsorbent at a room temperature. Next, the adsorbent is impregnated into a pore of the support and then is dried at a room temperature in an air atmosphere to use a final adsorbing molding with 320g.

In a comparative example, an adsorbent is synthesized by adding sodium silicate to a mixture of EB-PEI, tetraethylammonium phosphate, water, and ethanol (wherein the components have the same weight ratio as that of the experimental example), and the adsorbent is impregnated in the same support as that of the experimental example and then is dried at a room temperature in an air atmosphere to use a final adsorbing molding with 320g. The sodium silicate is included in an amount of 10 parts by weight based on 100 parts by weight of fumed silica.

In FIG. 6 and FIG. 7, the adsorbing molding is put in the one-pass reduction device of FIG. 3, 5% of CO₂ and 95% of N₂ are flowed at 50 liter/min (LPM), and adsorption capacity is measured while 50 liter/min (LPM) is maintained at 60 degrees for 5 minutes. “Upstream” indicates a concentration of the carbon dioxide before the carbon dioxide passes through the adsorbing molding within the one-pass reduction device, “Downstream” indicates a concentration of the carbon dioxide after the carbon dioxide passes through the adsorbing molding, and “Comparative Example” and “Experimental Example” indicate the carbon dioxide adsorption efficiency. It is confirmed that under an atmosphere condition of 5% of carbon dioxide similar to an exhaust gas of a ship, an average carbon dioxide absorption efficiency for 5 minutes of the experimental example that is 18.04% is improved by more than 2.5% over an average carbon dioxide absorption efficiency for 5 minutes of the comparative example that is 15.53%, and a duration time of a 15% carbon dioxide absorption efficiency of the experimental example that is 139 s is improved by more than 30% over a duration time of a 15% carbon dioxide absorption efficiency of the comparative example that is 107 s.

Although the embodiment of the present disclosure has been described with reference to the accompanying drawings, those skilled in the art will understand that the present disclosure may be implemented in another specific form without changing a technical idea or an essential feature thereof. Thus, it should be understood that the embodiments described above are just examples in all aspects and are not limited.

1. A method for manufacturing a dry-type carbon dioxide adsorbing molding manufactured in a large quantity, comprising:
sintering a support provided by extrusion molding a mixture of a support raw material and a binder at a predetermined temperature;
synthesizing an adsorbent by mixing a solvent, an amine compound, and a structure-directing agent in a reaction container; and
physically impregnating the adsorbent into a pore of the support and then drying the adsorbent.

2. The method of claim 1, wherein the binder is included in an amount of 50 to 70 parts by weight based on 100 parts by weight of the support raw material.

3. The method of claim 1, wherein the support raw material includes at least one selected from the group consisting of bentonite, attapulgite, kaolinite, montmorillonite, ball clay, fuller's earth, hectorite, palygorskite, saponite, sepiolite, halloysite, silica, calcium sulfate, zeolite, synthetic zeolite, alumina, fumed silica, activated charcoal, and metal organic framework.

4. The method of claim 1, wherein the binder includes methyl cellulose.

5. The method of claim 1, wherein the support is sintered at 500 to 600 degrees.

6. The method of claim 1, wherein the support has a polyhedral shape, a polygonal columnar shape, or a cylindrical shape.

7. The method of claim 1, wherein the synthesizing of the adsorbent is reacted without silicate.

8. The method of claim 1, wherein the adsorbent includes 25 to 35 wt % of the amine compound, 2 to 8 wt % of the structure-directing agent, and the remaining wt % of the solvent.

9. The method of claim 1, wherein the solvent includes at least one selected from the group consisting of water, methanol, ethanol, methyl chloride, carbon tetrachloride, and tetrahydrofuran.

10. The method of claim 1, wherein the amine compound includes at least one selected from the group consisting of ethylenediamine, triethylenetetramine, tetraethylenepentamine, pentaethylenehexamine, hexaethyleneheptamine, polyethyleneimine, and polypropyleneimine.

11. The method of claim 1, wherein the amine compound is polyethyleneimine modified by partial substitution with epoxybutane.

12. The method of claim 1, wherein the structure-directing agent includes at least one selected from the group consisting of tetramethylammonium phosphate (TMAH₂PO₄), tetraethylammonium phosphate (TEAH₂PO₄), tetrapropylammonium phosphate (TPAH₂PO₄), and tetrabutylammonium phosphate (TBAH₂PO₄).

13. A dry-type carbon dioxide adsorbing molding manufactured according to claim 1.
